(19) United States
(12) Patent Application Publication
(10) Pub. No.: US 2023/0416535 A1
(43) Pub. Date: Dec. 28, 2023

(54) GRINDING AID FOR TITANIUM DIOXIDE PARTICLES

(71) Applicant: Kronos International, Inc., Levrkusen (DE)

(72) Inventors: Mariusz Molon, Wuppertal (DE); Nicole Kolmer-anderl, Langenfeld (DE); Janine Siekman, Bergisch-Gladbach (DE); Sebastian Doedt, Schwelm (DE)

(73) Assignee: Kronos International, Inc., Leverkusen (DE)

(21) Appl. No.: 18/367,111

(22) Filed: Sep. 12, 2023

Related U.S. Application Data
(62) Division of application No. 17/449,912, filed on Oct. 4, 2021.

(30) Foreign Application Priority Data
Oct. 5, 2020 (EP) 20200083.2

(51) Int. Cl. C09C 1/36; B24D 3/34; C09C 3/04; C09C 3/06

(52) U.S. Cl. CPC C09C 1/3623; B24D 3/346; C09C 1/3661; C09C 3/041; C09C 3/063; C01P 2004/84

(57) ABSTRACT

The present invention relates to a grinding aid as well as a grinding method. Further, the present invention pertains to a titanium dioxide particle with a layer comprising a grinding aid as described herein and the use of said titanium dioxide particle in various applications.

### RELATED APPLICATION

This application is a divisional of U.S. patent application Ser. No. 14/449,912 filed on Oct. 4, 2023, which claims the benefit of Patent Application No. EP20200083.2 filed on Oct. 5, 2020.

### FIELD OF THE INVENTION

The present invention relates to a grinding aid as well as a grinding method. Further, the present invention pertains to a titanium dioxide particle with a layer comprising a grinding aid as described herein and the use of said titanium dioxide particle in various applications.

### TECHNOLOGICAL BACKGROUND OF THE PRESENT INVENTION

Titanium dioxide is commonly produced by either the chloride route or the sulphate route. Since titanium dioxide is photo catalytically active, it is unsuitable for a great variety of applications. In order to suppress the photocatalytic activity and depending on its end use, the titanium dioxide is subjected to an after-treatment process, in which one or more layers of substances are applied using a wet chemical process followed by a drying step. In the drying step, titanium dioxide agglomerates are formed which then have to be deagglomerated in a grinding step using a mill such as steam mill or an agitator ball mill.

The process steps described are carried out in a plant composed of various apparatuses and pipelines in which the titanium dioxide is processed. In order to prevent the system from clogging, in particular during the grinding step, a grinding aid is added to the titanium dioxide during the after-treatment process. These aids can be fed into the system at various points during the after-treatment process, for example, during drying or shortly before the titanium dioxide is fed into the mill. Various organic alcohols, amines and acids and its salts such as trimethlyolpropane (TMP), triisopropanolamine (TIPA) and dimethlolporpioinic acid (DMPA) are known in the art and commonly employed as grinding aids, including as described inin WO 99/13010.

Several conventional grinding aids will be reclassified by authorities and classified as environmentally harmful, carcinogenic and/or mutagenic, among other things. As a result, these aids can no longer be used, in particular not in connection with food and pharma applications.

There is thus a need in the art for a grinding aid which can be used safely and which is not classified as environmentally harmful, carcinogenic and/or mutagenic. Furthermore, the grinding aid should have good grinding properties and should prevent the system, in particular mills, from clogging. The grinding aid should additionally not adversely affect the optical properties of titanium dioxide particles used as pigments.

### OBJECT AND BRIEF DESCRIPTION OF THE PRESENT INVENTION

It is an object of the invention to provide a grinding aid which is not environmentally harmful, carcinogenic and/or mutagenic, exhibits good grinding properties and prevents apparatuses in which the particles are processed from clogging. It is moreover an object of the invention to provide a titanium dioxide particle with good flowability and when employed as a pigment the particle provides good optical properties.

It has been surprisingly found that the herein described grinding aid solves the above mentioned technical problems, i.e. the grinding aid is environmentally friendly and not carcinogenic and/or mutagenic, possesses good grinding properties and prevents the system in which the titanium dioxide particles are process, in particular mills, from clogging. The titanium dioxide having a layer thereon comprising a grinding aid as described herein exhibits moreover good flowability and great optical properties when the particle is used as a pigment.

Hence, in a first aspect, the invention refers to a grinding aid for grinding titanium dioxide particles as disclosed herein.

In a further aspect, the present invention is directed to a grinding method.

In a yet further aspect, the present invention pertains to a titanium dioxide particle having a layer thereon comprising a grinding aid as described herein.

In a final aspect, the present invention is directed to the use of a grinding aid as described herein for grinding titanium dioxide particles.

Further advantageous embodiments are covered by the claims.

### DESCRIPTION OF THE INVENTION

These and further aspects, features and advantages of the invention become apparent to the skilled person from a study of the following detailed description and claims. Each feature from one aspect of the invention may also be used in any other aspect of the invention. Further, of course, the examples contained herein are intended to describe and illustrate the invention, but not to limit it, and in particular, the invention is not limited to such examples. Numerical ranges stated in the form “from x to y” include the values mentioned and those values that lie within the range of the respective measurement accuracy as known to the skilled person. If several preferred numerical ranges are stated in this form, of course, all the ranges formed by a combination of the different end points are also included.

All percentages stated in connection with the compositions herein described relate to percent by weight (wt. %) unless explicitly stated otherwise, respectively based on the mixture of composition in question. The use of the term “about” is intended to encompass all values that lie within the range of the respective measurement accuracy known to the skilled person.

“At least one” as used herein relates to one or more, i.e. 1, 2, 3, 4, 5, 6, 7, 8, 9 or more. With respect to a layer, for example, the value relates to the layer and not to the absolute number of molecules in the layer.

The grinding aids disclosed in EP 20200083.2 are incorporated hereby by reference. A grinding aid for grinding titanium dioxide particles is preferably selected from the group consisting of silicate, silicate minerals, not including asbestos; silylated fumed silica, excluding asbestos; silylated precipitated silica; bentonite; zinc oxide; kaolin; boron nitride; mica; hydromagnesite; wollastonite; cristobalite; quartz; dolomite; huntite; siliceous earth; soda earth; manganese phosphite, calcium hydroxide; calcium oxide; magnesium hydroxide; magnesium oxide; antimony oxide; potassium hydroxide; sodium hydroxide; sodium sulfide; zinc sulfide; molybdenum disulfide; sodium borate; iron oxide; cupper iodide; aluminum oxide; sodium bisulfite; sodium nitrite; potassium iodide; sodium iodide; sulfur, sodium sulfite; potassium bromide; sodium thiosulfate; manganese chloride; copper bromide; barium nitrate; calcium chloride; manganese hypophosphite; lithium iodide; aluminum magnesium hydroxycarbonate; manganese oxide; calcium sulfoaluminate; barium tetraborate; ozocerite; pyrophyllite; hydrotalcite; manganese hydroxide; iron phosphide; barium hydroxide; zinc hydroxide; aluminum hydroxide; magnesium sodium fluoride silicate; hydrous magnesium silicate; titanium nitride; salts of acetyl acetic acids; C2-C24, aliphatic, linear chain, monocarboxylic acids, from natural fats and oils, and their mono-, di- and triglycerol esters, their branched fatty acids in naturally occurring amounts are included; C2-C24, aliphatic, linear monocarboxylic acids and their mono-, di- and triglycerol esters; esters of aliphatic monocarboxylic acids (C6-C22) with polyglycerol; aliphatic, monovalent, saturated, linear, primary (C4-C24) alcohols; linear with even number of carbon atoms (C12-C20) alkyl dimethylamines; alkyl(C8-C22)sulfonic acids; linear chain, primary, alkyl(C8-C22)sulfuric acids with even number of carbon chain; N,N-bis(2-hydroxyethyl)alkyl(C8-C18)amine; N,N-bis(2-hydroxyethyl)alkyl(C8-C18)amine hydrochloride; ethyl hydroxy methylcellulose; ethyl hydroxy propyl cellulose; glycine and salts thereof; lysine and salts thereof; methyl hydroxy methyl cellulose; polyacrylic acid and salts thereof; polyesters of 1,2-propanediol and/or 1,3- and/or 1,4-butanediol and/or polypropylene glycol with adipic acid, also with terminal acetic acid, or C12-C18 fatty acids, or n-octanol and/or n-decanol; polyethylene glycol (EO=1-50)-monoalkyl ether (linear and branched, C8-C20)-sulfate and salts thereof; propyl hydroxyethyl cellulose; propyl hydroxy methyl cellulose; propyl hydroxy propyl cellulose; sorbitol; ascorbic acid; hexadecyl trimethyl ammonium bromide; palmitic acid; stearic acid; ethylene diamine tetraacetic acid; benzoic acid; salicylic acid; camphor; citric acid; tartaric acid; 2,2′-methylene bis(4-ethyl-6-tert-butylphenol); o-phthalic acid; propyl 4-hydroxybenzoate; 4,4′-thiobis(6-tert-butyl-3-methylphenol); 2,2′-dihydroxy-5,5′-dichloro diphenylmethane; methyl 4-hydroxybenzoate; hexamethylene tetramine; caprolactam; 12-hydroxystearic acid; 2,4,6-triamino-1,3,5-triazine; succinic acid; maleic acid; fumaric acid; N,N′-ethylene-bis-stearamide; N,N′-ethylene-bis-oleamide; glutaric acid; erucic acid; pentaerythritol; 2,2′-methylenebis(4-methyl-6-tert-butylphenol); benzophenone; ethyl 4-hydroxybenzoate; Propyl gallate; triisopropanolamine; levulinic acid; adipic acid; sucrose octaacetate; dipentaerythritol; diphenyl sulfone; 2,6-di-tert-butyl-p-cresol; 2,2′-dihydroxy-4-methoxybenzophenone; 2,4-Dihydroxybenzophenone; 2-hydroxy-4-methoxybenzophenone; ascorbyl palmitate; butyl lactate; malonic acid; lauric acid; oxalic acid; oleamide; n-decanoic acid; silicon carbide; dicyandiamide; arachidic acid; lignoceric acid; 4,4′-dihydroxybenzophenone; octyl gallate; dodecyl gallate; 1,2-propylene glycol monostearate; 4,4′-bis(2-benzoxazolyl)stilbene; 2-hydroxy-4-n-octyloxybenzophenone; 2-(2′-hydroxy-5′-methylphenyl)benzotriazole; pyrophosphoric acid; dioctadecyl disulfide; crotonic acid; 2,6-di-tert-butyl-4-ethylphenol; isopropyl-4-hydroxybenzoate; tetrakis[3-(3,5-di-tert-butyl-4-hydroxyphenyl)propionate]; malic acid; montan wax; candelilla wax; carnauba wax; carboxymethyl cellulose; cellulose; cellulose acetate butyrate; ethyl cellulose; ethyl hydroxyethyl cellulose; methyl ethyl cellulose; hydroxyethyl cellulose; hydroxypropyl cellulose; hydroxypropyl methylcellulose; methyl cellulose; food starch; hydroxyethyl starch; alginic acid; 1,2-propylene glycol alginate; hydroxyethylmethyl cellulose; hydroxypropyl starch; alpha-dextrin; boric acid; ascorbyl stearate; glycerin tribehenate; polyethylene glycol; polypropylene glycol; sorbitan monopalmitate; sorbitan tristearate; sorbitan monostearate; 1,3,5-tris(3,5-di-tert-butyl-4-hydroxybenzyl)-1,3,5-triazin-2,4,6(1H,3H,5H)-trion; glyceryl monobehenate; tris(2,4-di-tert-butylphenyl)phosphite; dibenzyliden sorbitol; carboxymethyl ethyl cellulose; carboxymethyl methyl cellulose; hydroxy methylcellulose; monoethyl-3,5-di-tert-butyl-4-hydroxy-benzylphosphonate and calcium salt; 1-(2-hydroxyethyl)-4-hydroxy-2,2,6,6-tetramethylpiperidine dimethyl succinate and a copolymer; N-methacryloyloxyethyl-N,N-dimethyl-N-carboxymethyl ammonium chloride or sodium salt-octadecyl methacrylate-ethyl methacrylate-cyclohexyl methacrylate-N-vinyl-2-pyrrolidone and copolymers thereof; hydrolyzed starch; polyethylene glycol(EO=2-6)-monoalkyl (C16-C18)-ether; regenerated cellulose; p-cresol-dicyclopentadiene-isobutylene and copolymers thereof; bis(polyethylene glycol) hydroxymethyl phosphonate; polyethylene glycol-30-dipolyhydroxystearate; 2,2′-oxamidobis[ethyl-3-(3,5-di-tert-butyl-4-hydroxyphenyl)propionate]; poly[6-[(1,1,3,3-tetramethylbutyl)amino]-1,3,5-triazine-2,4-diyl]-[(2,2,6,6-tetramethyl-4-piperidyl)imino-hexamethylene-[(2,2,6,6-tetramethyl-4-piperidyl)imino]; bis(4-ethylbenzylidene)sorbitol; 2,2′,2″-nitrilo(triethyl-tris(3,3′,5,5′-tetra-tert-butyl-1,1′-bi-phenyl-2,2′-diyl)phosphite); bis(2,6-di-tert-butyl-4-methylphenyl)pentaerythritol diphosphite; 2,2′-methylene-bis(4,6-di-tert-butylphenyl)sodium phosphate; bis(methylbenzylidene)sorbitol; 2,4-bis(octylthiomethyl)-6-methylphenol; 2,4-bis(dodecylthiomethyl)-6-methylphenol; 2,2′-Ethylidene-bis(4,6-di-tert-butylphenyl)fluorophosphonite; reaction product of di-tert-butylphosphonite with biphenyl, produced by condensation of 2,4-di-tert-butylphenol with the Friedel-Crafts reaction product of phosphorus trichloride and biphenyl; 2,4-di-tert-pentyl-6-[1-(3,5-di-tert-pentyl-2-hydroxyphenyl)ethyl]phenyl acrylate; 3,3-bis(methoxymethyl)-2,5-dimethylhexane; 2,4-dimethyl-6-(1-methylpentadecyl)phenol; bis(3,4-dimethylbenzylidene)sorbitol; 1,2-bis(3-aminopropyl)ethylenediamine, polymer with N-butyl-2,2,6,6-tetramethyl-4-piperidineamine and 2,4,6-trichloro-1,3,5-triazine; N,N′-dicyclohexyl-2,6-naphthalene dicarboxamide; pentaerythritol tetrakis (2-cyano-3,3-diphenyl acrylate); 9,9-bis(methoxymethyl)fluorene; 1,3,5-tris(4-benzoylphenol)benzene; polydimethylsiloxane with 3-aminopropyl end groups, polymer with 1-isocyanato-3-isocyanatomethyl-3,5,5-trimethylcyclohexane; 1,3,5-tris(2,2-dimethylpropanamido)benzene; hydrogenated homopolymers and/or copolymers prepared from 1-hexene and/or 1-octene and/or 1-decene and/or 1-dodecene and/or 1-tetradecene with a molecular weight of 440 to 12,000 g/mol; N,N′-bis(2,2,6,6-tetramethyl-4-piperidyl)-N,N′-diformylhexamethylenediamine; 2,2′-(1,4-phenylen)bis((4H-3,1-benzoxazin-4-on); polyester of adipic acid with 1,3-butanediol, 1,2-propanediol and 2-ethyl-1-hexanol; polyethylene glycol ethers (EO=1-50) of linear and branched primary alcohols (C8-C22); aliphatic linear C2-C24 monocarboxylic acids from natural oils and fats, lithium salt; ethoxylated secondary alcohols with C12-C14 with a beta-(2-hydroxyethoxy) group; alpha-alkenes (C20-C24), copolymer with maleic anhydride, reaction product with 4-amino-2,2,6,6-tetramethylpiperidine; bis(4-propylbenzylidene)propylsorbitol; neopentyl glycol, diesters and monoesters with benzoic acid and 2-ethylhexanoic acid; oxidized polyethylene waxes; sulfosuccinic acid, alkyl (C4-C20) or cyclohexyl diesters and salts thereof; sulfosuccinic acid monoalkyl (C10-C16) polyethylene glycol esters and salts thereof; cis-1,2-cyclohexanedicarboxylic acid and salts thereof; cis-endo-bicyclo[2.2.1]heptane-2,3-dicarboxylic acid and salts thereof; neodecanoic acid and salts thereof; pimelic acid and salts thereof; stearoyl-2-lactylate and salts thereof; N,N′,N″-tris(2-methylcyclohexyl)-1,2,3-propane-tricarboxamide; poly(12-hydroxystearic acid) stearate; fatty acids (C8-C22) from animal or vegetable fats and oils, esters with monohydric, primary, saturated, aliphatic, C3-C22 branched alcohols; fatty acids (C8-C22) from animal or vegetable fats and oils, esters with linear, monohydric, primary, saturated, aliphatic alcohols (C1-C22); fatty acids (C8-C22), esters with pentaerythritol and mixtures thereof. “Salts”, as used herein, refers to compounds with sodium, potassium, lithium, calcium and magnesium used as counterions if not indicated otherwise. These grinding media according to the invention all exhibit good grinding properties. These grinding aids reduce the conveying pressure and prevent clogging of the production equipment, in particular the mill in which the particles are ground. They also improve flow properties in plastics and compatibility in certain matrices.

Preferably, the grinding aid is inorganic and selected from the group consisting of silicate, silicate minerals, not including asbestos; silylated fumed silica, excluding asbestos; silylated precipitated silica; bentonite; zinc oxide; kaolin; boron nitride; mica; hydromagnesite; wollastonite; cristobalite; quartz; dolomite; huntite; siliceous earth; soda earth; manganese phosphite, calcium hydroxide; calcium oxide; magnesium hydroxide; magnesium oxide; antimony oxide; potassium hydroxide; sodium hydroxide; sodium sulfide; zinc sulfide; molybdenum disulfide; sodium borate; iron oxide; cupper iodide; aluminum oxide; sodium bisulfite; sodium nitrite; potassium iodide; sodium iodide; sulfur, sodium sulfite; potassium bromide; sodium thiosulfate; manganese chloride; copper bromide; barium nitrate; calcium chloride; manganese hypophosphite; lithium iodide; aluminum magnesium hydroxycarbonate; manganese oxide; calcium sulfoaluminate; barium tetraborate; ozocerite; pyrophyllite; hydrotalcite; manganese hydroxide; iron phosphide; barium hydroxide; zinc hydroxide; aluminum hydroxide; magnesium sodium fluoride silicate; hydrous magnesium silicate; titanium nitride and mixtures thereof. These inorganic grinding aids have the advantage over organic grinding media that the organic grinding media tend to decompose at elevated temperatures and/or are disadvantageous due to their environmentally harmful properties. Therefore, conventional organic grinding media may have to be removed after grinding, requiring additional process steps that are costly and time-consuming. Removal of inorganic agents is not necessary because they do not have these disadvantages. They are more temperature stable than conventional, organic grinding agents.

In a more preferred embodiment of the invention, the grinding aid is inorganic and selected from the group consisting of fumed silica, precipitated silica, colloidal silica, and talc. Aside from advantages described in connection with inorganic grinding aids above, the grinding aids exhibit particularly good grinding properties. In addition, the grinded titanium dioxide particles grinded with these grinding aids possess excellent optical characteristics when the particles are used as pigments.

Preferably, the grinding aid for grinding titanium dioxide particles possesses a size (d50m) of from about 0.3 to about 100 μm, preferably about 1 to about 50 μm and particularly preferred of from about 2 to about 25 μm.

The titanium dioxide particles according to the invention are obtained by the sulphate or the chloride process. Further, said particles may be present in the crystal structures of rutile, anatase or brookite, usually in the crystal structures of rutile or anatase. Rutile is particularly suitable as compared to anatase because of its lower photolytic catalytic activity. Preferably, said titanium dioxide particles consists of at least about 98 wt. %, preferably of at least about 99 wt. % rutile referred to the total weight of said particles.

When the titanium dioxide particles are used as titanium dioxide pigment particles, said particles possess a primary size such that they scatters the visible light is scatter, ideally to a high rate. The particle size is the mass-related median d50 (hereinafter: d50) of from about 200 nm to about 500 nm, preferably of from about 200 nm to about 400 nm determined by disc centrifuge.

The titanium dioxide particles are preferably in the form of primary particles as opposed to agglomerates. A primary particle, as used herein, relates to a particle which may form together with at least one other particle to form agglomerates and aggregates. This definition of primary particles also covers twins and multiple twins, which are known in the art and can be analyzed by, for example, TEM analysis.

In a further aspect, the present invention pertains to a grinding method for grinding titanium dioxide particles which is characterized in that the grinding aid as described herein is employed. Preferably, about 0.001 to about 10 wt. %, preferably about 0.01 to about 5 wt. %, and more preferably about 0.1 to about 1 wt. % of the grinding aid based on the total weight of the titanium dioxide pigment particles is employed. The titanium dioxide particles which are subject of the grinding method are preferably titanium dioxide pigment particles.

In a preferred embodiment of the grinding method, the grinding aid is added to the titanium dioxide particles in a milling step which can be conducted in any appropriate mill such as jaw crushers, gyratory crushers, heavy-duty impact mills, roll crushers, dry pans and chaser mills, shredders, media mills, medium peripheral-speed mills, high-peripheral-speed mills, fluid-energy superfine mills, preferably in a steam mill or in an agitator ball mill. In case a layer is applied onto the titanium dioxide particle such as at least one of silicon dioxide, aluminum oxide, zircon dioxide, titanium dioxide, the grinding aid can be added alternatively in the same step such that it is contained in said layer. In addition, the layer which also comprises the grinding aid is the outmost layer. The grinding aid can also be added shortly before the titanium dioxide particles are subject to milling. The grinding aid can be added as it is, or dispersed or diluted in a solvent such as an aqueous solvent or an organic solvent which are known in the art.

In a further aspect, the invention relates to titanium dioxide particles obtainable by a grinding method according to the method described herein.

In another aspect, the invention relates to a titanium dioxide particle having a layer thereon comprising a grinding aid as described herein. In general, the layer might be applied directly on the particle surface. Alternatively, between the layer and the particle, further layers might be present. Preferably, said layer comprises at least one of silicon dioxide, aluminum oxide, zircon dioxide, and titanium dioxide. For example, on the particle surface a silicon dioxide layer, preferably a dense silicon dioxide layer is applied, and on this silicon dioxide layer, an aluminum layer is applied. The outmost layer, i.e. the layer most remote from the titanium dioxide particle, preferably comprises the grinding aid.

In another aspect, the invention pertains to the use of a grinding aid as described herein for grinding titanium dioxide particles.

### Experimental Section

Test and Measurements Methods

a) Particle Size and Mass Related Median d50m

The size of the pigment particles was determined by using a CPS Disc centrifuge, Model DC 20000 available from CPS Instrument, Inc. located in Florida, United States of America. The sample was prepared by obtaining a first premix by mixing 2 g of a dry pigment particles with 80 g sodium hexametaphosphate (0.06 mass % in water) commercially available from BK Giulini GmbH in Ladenburg, Germany, under the name Calgon N until the first premix was homogenized. Subsequently, 2 g of this first premix were added to 48 g Calgon N, and again sufficiently homogenized by mixing to obtain a second premix. 100 pi of this second premix were used as the sample for determining the particle size. The centrifuge was operated at 3,000 rpm. The calibration standard parameters were as follows:
Particle density: 1.385 g/mL
Peak diameter: 1.27 microliters
Half height peak width: 0.08 microliters
The fluid parameters were as follows:
Fluid density: 1.045 g/mL
Fluid refraction index: 1.344
Fluid viscosity: 1.2 cps.

b) Determination of the Grinding Aid Size

The size was determined by dynamic light scattering according to ISO 13320-1. According to the invention the median diameter is the mass-related median d50 (d50m).

c) Tinting Strength

The tinting strength (TS) was measured by means of the MAB Test. In this context, the pigment to be tested is incorporated into a black paste according to DIN 53165 on an automatic muller. The pigment volume concentration is 17%. The grey paste produced is applied to a Morest chart, and a Hunter Colorimeter PD-9000 is used to determine the reflectance values of the layer in wet condition. The TS values derived are referred to an internal standard.

d) WBT Brightness L*

Said brightness was measured by mixing a sample of the to be tested with water to result in a mixture with a PVC of 17% in water. Equal parts of the mixture obtained are mixed to give white or gray emulsion paints. L* is measured on the dry prints of these inks. The measurement takes place with the X-Rite VS 450 color spectrometer.

### Examples

The samples were produces as follows: titanium dioxide particles (10 kg) which are commercially available as K2190 from KRONOS INTERNATIONAL, Inc. in Leverkusen, Germany, and are titanium dioxide pigment particles were provided and mixed with grinding aid for 10 min at 30 rpm in the mixer Mixomat. The amount of the grinding aid added is provided in Table 1 below.

The samples produced were tested as regards their tinting strength (TS), brightness and bulk weight. The corresponding values are indicated in Table 1.

TABLE 1
Results of the testing.

| | | | WBT | Bulk weight |
|---|---|---|---|---|
| | Composition | TS | Brightness L* | [kg/m³] |
| Example 1 | K2190 + 0.3 | 105.3 | 97.7 | — |
| | wt. % talcum | | | |
| Example 2 | K2190 + 1.0 | 104.9 | 97.7 | 566 |
| | wt. % talcum | | | |
| Example 3 | K2190 + 0.3 | 106.0 | 98.0 | — |
| | wt. % fumed | | | |
| | silica | | | |
| Example 4 | K2190 + 1 wt. % | 106.2 | 97.9 | 496 |
| | fumed silica | | | |
| Example 5 | K2190 + 0.3 | 105.8 | 97.8 | — |
| | wt. % precipitated | | | |
| | silica | | | |
| Example 6 | K2190 + 1 wt. % | 104.8 | 97.9 | 537 |
| | precipitated | | | |
| | silica | | | |
| Comparative | K2190 + 1 wt. % | 103.2 | 97.4 | 813 |
| Example 1 | TMP | | | |

It can be seen that the TS of the titanium dioxide pigment particles of the Examples 1 to 6 according to the invention are superior over the TS of the Comparative Example 1, a sample which was treated with the conventional grinding aid TMP. It can also be seen that the WBT brightness for Examples 1 to 6 is at least as good as that of the Comparative Example 1. The bulk weights indicate that the grinding aids according to the invention disperse and stabilize the pigment particles to a higher degree compared to the Comparative Example 1. It is concluded that the flowability is thus improved which corresponds to the observation made with respect to the conveying pressure in the apparatuses when the grinded pigment particles were processed.

The above descriptions of certain embodiments are made for the purpose of illustration only and are not intended to be limiting in any manner. Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is claimed is:

1. A method of grinding titanium dioxide pigment particles, the method comprising:
supplying titanium dioxide pigment particles in a steam mill;
supplying a grinding aid in the steam mill, wherein the grinding aid has a size (d50m) of from about 0.3 μm to about 100 μm; and
milling the titanium dioxide pigment particles with the grinding aid in the steam mill; wherein the grinding aid is selected from the group consisting of the group consisting of fumed silica, precipitated silica, colloidal silica, talc and mixtures thereof.

2. The method of claim 1, wherein the step of supplying the grinding aid is accomplished by adding the grinding aid to the titanium dioxide pigment particles before the titanium dioxide pigment particles are supplied to the steam mill.

3. The method of claim 2, further comprising:
applying a layer of at least one of silicon dioxide, aluminum oxide, zircon dioxide, and titanium dioxide onto the titanium dioxide pigment particles and adding the grinding aid while applying the layer such that the grinding aid is contained in the layer.

4. The method of claim 3, wherein the layer comprising the grinding aid is the outermost layer on the titanium dioxide pigment particles.

5. The method of claim 1, wherein the grinding aid possesses a size (d50m) of from about 1 to about 50 μm.

6. The method of claim 5, wherein the grinding aid possesses a size (d50m) of from about 2 to about 25 μm.

7. The method of claim 1 wherein the grinding aid is used in an amount that is from about 0.001 to about 10 wt. % based on the total weight of the titanium dioxide particles.

8. The method of claim 7 wherein the grinding aid is used in an amount that is from about 0.01 to about 5 wt. % based on the total weight of the titanium dioxide particles.

9. The method of claim 8 wherein the grinding aid is used in an amount that is from about 0.1 to about 1 wt. % based on the total weight of the titanium dioxide particles.

10. The method of claim 1, wherein the step of supplying the grinding aid comprises dispersing or diluting the grinding aid in a solvent.

11. The method of claim 10, wherein the solvent is an aqueous solvent.

12. The method of claim 10, wherein the solvent is an organic solvent.

13. The method of claim 1, wherein the grinding aid is added to the titanium dioxide pigment particles during the step of milling in the steam mill.

14. Titanium dioxide particles obtained by the grinding method according to claim 1.

15. The titanium dioxide particle of claim 14, wherein the grinding aid comprises a layer on the titanium dioxide particles, wherein said layer comprises at least one of silicon dioxide, aluminum oxide, zircon dioxide, and titanium dioxide.
